(19) United States
(12) Patent Application Publication
(10) Pub. No.: US 2025/0386235 A1
(43) Pub. Date: Dec. 18, 2025

(54) LOCAL DEVICE RADIO CONFIGURATION ADAPTATION

(71) Applicant: Dell Products L.P., Round Rock, TX (US)

(72) Inventors: Ali Esswie, Calgary (CA); Ibrahim AbuAlhaol, Nepean (CA)

(21) Appl. No.: 18/742,721

(22) Filed: Jun. 13, 2024

(51) Int. Cl. H04W 28/02; H04W 72/51; H04W 72/543; H04W 76/10

(52) U.S. Cl. CPC H04W 28/0221; H04W 72/51; H04W 72/543; H04W 76/10

(57) ABSTRACT

Responsive to receiving one or more connection establishment requests corresponding to one or more extended reality appliances associated with an extended reality intermediate processing unit, a radio network node may determine multiple configuration blocks corresponding to the appliances, or applications, predicted user behaviors, or qualities-of-service corresponding to the appliances. The configuration blocks may be indicative of radio settings usable to deliver traffic transmitted by the appliances. The node may transmit a configuration block message to the processing unit comprising an indication of the determined configuration blocks. The processing unit, using one or more learning models, may assign a configuration block to traffic corresponding to an appliance based on predicted appliance user behavior, radio channel conditions, or traffic quality-of-service. If the processing unit indicates to the node a determined/adapted configuration block, the node may decode received traffic according to the indicated configuration block and avoid blind decoding of the traffic.

### BACKGROUND

The ‘New Radio’ (NR) terminology that is associated with fifth generation mobile wireless communication systems (“5G”) refers to technical aspects used in wireless radio access networks (“RAN”) that comprise several quality of service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose on a given RAN resource loads, or demands, that vary. A RAN node may activate a network energy saving mode to reduce power consumption.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise facilitating, by a radio network node comprising at least on processor, receiving, from at least one first user equipment, a configuration block capability indication indicative that the at least one first user equipment is configured to facilitate operation of at least one second user equipment according to at least one radio configuration to be selectable by the at least one first user equipment with respect to at least one user equipment characteristic that corresponds to the at least one second user equipment. The method may further comprise facilitating, by the radio network node, receiving at least one connection establishment request corresponding to the at least one second user equipment. Based on at least one radio characteristic that corresponds to the at least one second user equipment, the method may further comprise determining, by the radio network node, the at least one radio configuration associated with the at least one radio characteristic. Responsive to the at least one connection establishment request and based on the configuration block capability indication, the method may further comprise facilitating, by the radio network node, transmitting, to the at least one first user equipment, at least one configuration block message comprising at least one configuration block indicative of the at least one radio configuration. The method may further comprise facilitating, by the radio network node, receiving traffic that was transmitted, by at least one of the at least one second user equipment, according to at least one of the at least one radio configuration.

The at least one radio characteristic may comprise at least one application type associated with at least one application to be executed by the at least one second user equipment. The at least one radio characteristic may comprise at least one quality-of-service that corresponds to at least one communication session to be conducted between one or more of the at least one second user equipment and the radio network node. The at least one radio characteristic may comprise a capability or quality corresponding to the at least one second user equipment, for example a processor capability, a buffer size, an antenna configuration, and the like.

In an example embodiment, the at least one configuration block message may comprise an adaptation mode indication indicative of a transparent configuration block adaptation mode. The receiving of the traffic according to the at least one of the at least one radio configuration may comprise blind decoding, by the radio network node, of the traffic.

In an example embodiment, the at least one configuration block message may comprise an adaptation mode indication indicative of a nontransparent configuration block adaptation mode. The method may further comprise facilitating, by the radio network node, receiving, from the at least one first user equipment, at least one radio configuration adaptation report indicative of at least one determined radio configuration of the at least one radio configuration. The receiving of the traffic according to the at least one of the at least one radio configuration may comprise avoiding blind decoding of the traffic and receiving the traffic according to at least one radio configuration setting that corresponds to the at least one determined radio configuration indicated by the at least one radio configuration adaptation report. The at least one determined radio configuration may be determined by the at least one first user equipment. Determination of the at least one determined radio configuration by the at least one first user equipment may comprise determination of an adapted configuration block of the at least one configuration block associated with the at least one determined radio configuration based on the at least one user equipment characteristic.

In an example embodiment, the at least one user equipment characteristic may comprise at least one haptic characteristic that corresponds to use, associated with a user action, of the at least one of the at least one second user equipment. The at least one haptic characteristic may comprise at least one of: at least one eye movement, at least one movement of the at least one second user equipment, at least one pulse rate, at least one blood pressure value, at least one voice intonation, at least one skin moisture value, or at least one grip pressure value.

In an example embodiment, the at least one user equipment characteristic may be predicted by the at least one first user equipment, according to at least one learning model, to result in at least one predicted user equipment characteristic, and wherein the adapted configuration block may be determined based on the at least one predicted user equipment characteristic. At least one input to the at least one learning model may comprise at least one of: at least one network parameter metric representative of at least one first metric representative of at least one network parameter, at least one network traffic parameter metric representative of at least one second metric representative of at least one network traffic parameter, at least one user equipment behavior parameter metric representative of at least one third metric representative of at least one user equipment behavior parameter, or at least one user behavior parameter metric representative of at least one fourth metric representative of at least one user behavior parameter.

In an example embodiment, the at least one user equipment characteristic may comprise at least one of: at least one application characteristic associated with at least one application being executed by the at least one of the at least one second user equipment, at least one radio capability, at least one radio channel condition, or at least one quality of service associated with the at least one application.

In an example embodiment, the at least one second user equipment may comprise an extended reality appliance. In an example embodiment, the at least one first user equipment may comprise an extended reality intermediate processing unit.

In another example embodiment, a radio network node may comprise at least one processor configured to process executable instructions that, when executed by the at least one processor, may facilitate performance of operations that may comprise receiving, from an extended reality processing unit, a configuration block capability indication indicative that the extended reality processing unit is configured to select at least one radio configuration block comprising at least one radio setting indication indicative of at least one radio parameter setting that corresponds to at least one extended reality appliance. The at least one radio parameter setting may be usable to transmit traffic to the radio network node. The operations may further comprise receiving at least one connection establishment request, corresponding to the at least one extended reality appliance, indicative of at least one appliance characteristic that corresponds to the at least one extended reality appliance. Based on the at least one appliance characteristic, the operations may further comprise determining the at least one radio configuration block to result in at least one determined radio configuration block. Responsive to the at least one connection establishment request and based on the configuration block capability indication, the operations may further comprise transmitting, to the extended reality processing unit, at least one configuration block message comprising at least one configuration block indication indicative of the at least one determined radio configuration block. The operations may further comprise receiving, from the extended reality processing unit according to a selected radio configuration, traffic transmitted by at least one of the at least one extended reality appliance. The selected radio configuration may correspond to a selected configuration block selected, by the extended reality processing unit from the at least one determined configuration block, based on at least one of the at least one appliance characteristic that corresponds to the at least one extended reality appliance.

In an example embodiment, the operations may further comprise receiving, from the extended reality processing unit, at least one radio configuration adaptation report indicative of the selected configuration block. The receiving of the traffic may comprise avoiding blind decoding of the traffic and receiving the traffic according to at least one radio configuration setting that corresponds to the selected radio configuration indicated by the at least one radio configuration adaptation report. The configuration block capability indication may be indicative that the extended reality processing unit is capable of using a trained machine learning model to predict the at least one of the at least one appliance characteristic to determine the selected configuration block indicated by the at least one radio configuration adaptation report.

In an example embodiment, a non-transitory machine-readable medium may comprise executable instructions that, when executed by at least one processor of a radio network node, may facilitate performance of operations that may comprise receiving, from an extended reality processing unit, a configuration block capability indication indicative that the extended reality processing unit is configured to select at least one radio configuration block comprising at least one radio setting indication indicative of at least one radio parameter setting to be usable by at least one extended reality appliance to transmit traffic to the radio network node and receiving, from the at least one extended reality appliance, at least one connection establishment request indicative of at least one appliance characteristic that corresponds to the at least one extended reality appliance. Based on the at least one appliance characteristic, the operations may further comprise determining the at least one radio configuration block to result in at least one determined radio configuration block. Responsive to the at least one connection establishment request and based on the configuration block capability indication, the operations may further comprise transmitting, to the extended reality processing unit, at least one configuration block message comprising at least one configuration block indication indicative of the at least one determined radio configuration block. The operations may further comprise receiving, according to a selected radio configuration, traffic, transmitted by at least one of the at least one extended reality appliance. The selected radio configuration may correspond to a selected configuration block selected, by the extended reality processing unit from the at least one determined configuration block, based on at least one predicted appliance characteristic of the at least one appliance characteristic.

In an example embodiment, the extended reality processing unit may use at least one trained learning model to predict the at least one predicted appliance characteristic.

In an example embodiment, the operations may further comprise receiving, from the extended reality processing unit, at least one radio configuration adaptation report indicative of the selected configuration block. The receiving of the traffic may comprise receiving the traffic according to at least one radio configuration setting that corresponds to the selected radio configuration indicated by the at least one radio configuration adaptation report without performing any blind decoding of the traffic.

### BRIEF DESCRIPTION OF THE DRAWINGS

FIG. 1 illustrates wireless communication system environment.

FIG. 2 illustrates an example virtual reality appliance.

FIG. 3 illustrates an example environment with an extended reality appliance tethered to an intermediate processing unit user equipment.

FIG. 4 illustrates example configuration block capability indication information.

FIG. 5 illustrates radio configuration adaptation report information.

FIG. 6 illustrates a timing diagram of an example embodiment of a radio network node receiving traffic, transmitted by an extended reality appliance, according to radio configuration information determined by an extended reality intermediate processing unit located proximate the extended reality appliance.

FIG. 7 illustrates a flow diagram of an example embodiment method of using determined configuration information to receive traffic transmitted by an extended reality appliance.

FIG. 8 illustrates a block diagram of an example method embodiment.

FIG. 9 illustrates a block diagram of an example radio network node.

FIG. 10 illustrates a block diagram of an example non-transitory machine-readable medium embodiment.

FIG. 11 illustrates an example computer environment.

FIG. 12 illustrates a block diagram of an example wireless user equipment.

FIG. 13 illustrates an example learning model arrangement that facilitated determining, by an extended reality appliance, a configuration block, to be used by the appliance, based on user equipment characteristic information processed by the learning model arrangement.

FIG. 14 illustrates a table of example characteristic information.

### DETAILED DESCRIPTION

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. In yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

As an example use case that illustrates example embodiments disclosed herein, Virtual Reality (“VR”) applications and VR variants, (e.g., mixed and augmented reality) may at some time perform best when using NR radio resources associated with URLLC while at other times lower performance levels may suffice. A virtual reality smart glass device may consume NR radio resources at a given broadband data rate having more stringent radio latency and reliability criteria to provide a satisfactory end-user experience.

5G systems should support ‘extended reality’ (“XR”) services. XR services may refer to, or may be referred to as, anything reality services. XR services may comprise VR applications, which are widely adopted XR applications that provide an immersive environment that can stimulate the senses of an end user such that he, or she, may be ‘tricked’ into the feeling of being within a different environment than he, or she, is actually in. XR services may comprise Augmented Reality (‘AR’) applications that may enhance a real-world environment by providing additional virtual world elements via a user's senses that focus on real-world elements in the user's actual surrounding environment. XR services may comprise Mixed Reality cases (“MR”) applications that help merge, or bring together, virtual and real worlds such that an end-user of XR services interacts with elements of his, or her, real environment and virtual environment simultaneously.

Different XR use cases may be associated with certain radio performance targets. Common to XR cases, and unlike URLLC or eMBB, high-capacity links with stringent radio and reliability levels are typically needed for a satisfactory end user experience. For instance, compared to a 5 Mbps URLLC link with a 1 ms radio budget, some XR applications need 100 Mbps links with a couple of milliseconds of allowed radio latency. Thus, 5G radio design and associated procedures may be adapted to the new XR QoS class and associated performance targets.

An XR service may be facilitated by traffic having certain characteristics associated with the XR service. For example, XR traffic may typically be periodic with time-varying packet size and packet arrival rate. In addition, different packet traffic flows of a single XR communication session may affect an end user's experience differently. For instance, a smart glass that is streaming 180-degree high-resolution frames may use a large percentage of a broadband service's capacity for fulfilling a user experience. However, frames that are to be presented to a user's pose direction (e.g., front direction) are the most vital for an end user's satisfactory user experience while frames to be presented to a user's periphery vision have less of an impact on a user's experience and thus may be associated with a lower QoS requirement for transport of traffic packets as compared to a QoS requirement for transporting the pose-direction traffic flow. Therefore, flow differentiation that prioritizes some flows, or some packets, of a XR session over other flows or packets may facilitate efficient use of a communication system's capacity to deliver the traffic. Furthermore, XR capable devices (e.g., smart glasses, projection wearables, etc.) may be more power-limited than conventional mobile handsets due to the limited form factor of the devices. Thus, techniques to maximize power saving operation at an XR capable device is desirable. Accordingly, a user equipment device accessing XR services, or traffic flows of an XR session, may be associated with certain QoS parameter criterion/criteria to satisfy performance targets of the XR service. Measured traffic values, or metrics, may correspond to a QoS, or analyzed with respect to, parameter criterion/criteria, such as, for example, a data rate, an end-to-end latency, or a reliability.

High-capacity-demanding services, such as virtual reality applications, may present performance challenges to even 5G NR capabilities. Thus, even though 5G NR systems may facilitate and support higher performance capabilities, the radio interface should nevertheless be optimized to support extreme high capacity and low latency requirements of XR applications and XR data traffic.

Multi-modal XR applications may integrate different technologies to offer a versatile and comprehensive user experience. For example, a multi-modal XR application might use VR to immerse users in a virtual training environment and then seamlessly switch to AR or MR to provide real-time feedback or overlay instructional information corresponding to physical objects that may appear in an environment viewed by an XR user. Such feedback or instructional information may relate to stationary objects or may be information that does not change frequently and may be referred to as stable information.

An advantage of multi-modal XR applications is the adaptability to facilitate different contexts and different user preferences. An XR application can provide varying levels of immersion and interaction, allowing users to choose the most suitable mode of engagement based on the user's needs or the specific task at hand. Additionally, multi-modal XR can enable collaborative experiences, allowing users in different physical locations to interact within the same virtual space.

Uses of multi-modal XR applications extend beyond entertainment and gaming, with widespread adoption in fields such as healthcare, education, engineering, and marketing. Medical practitioners can use multi-modal XR applications to simulate complex surgeries, educators can create interactive and immersive learning experiences, and architects can visualize and modify building designs in real-time.

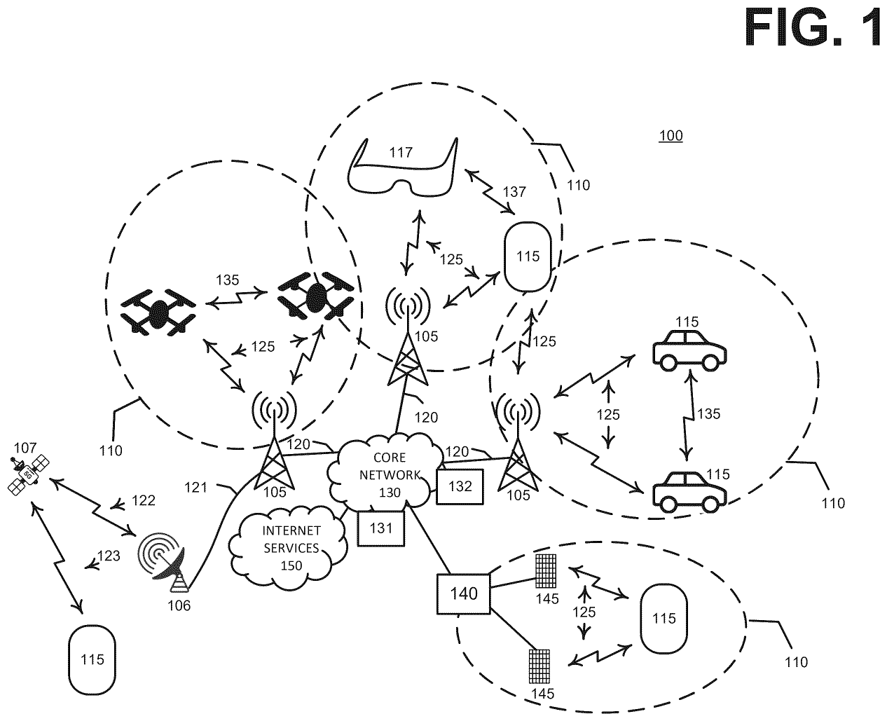

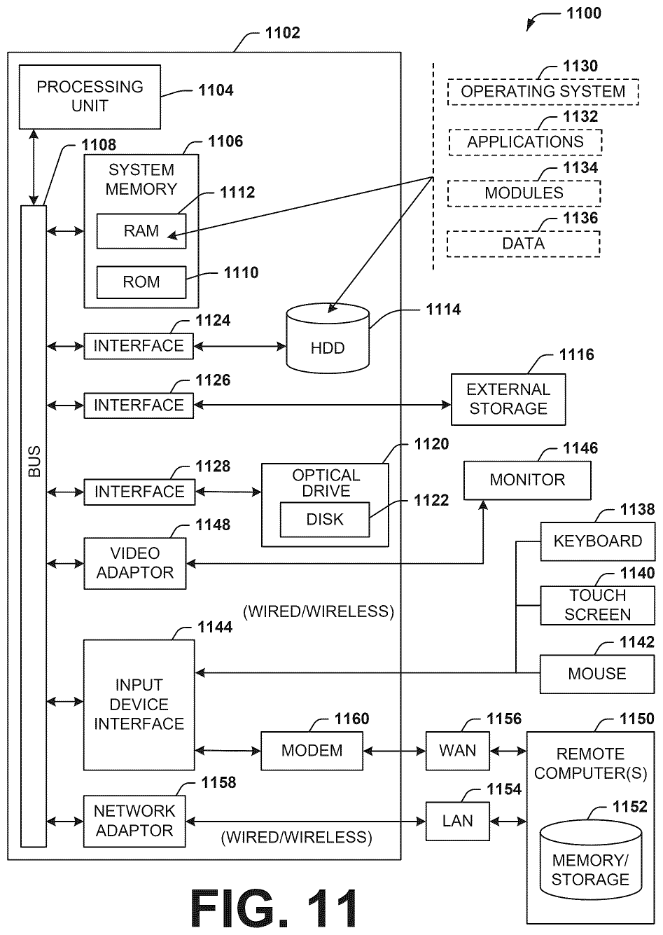

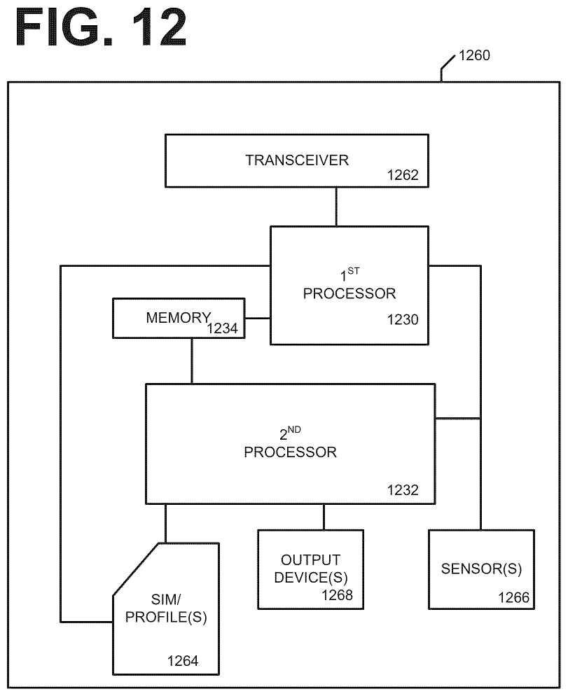

Turning now to the figures, FIG. 1 illustrates an example of a wireless communication system 100. The wireless communication system 100 may include one or more base stations 105, one or more user equipment (“UE”) devices 115, and core network 130. In some examples, the wireless communication system 100 may comprise a long-range wireless communication network, that comprises, for example, a Long-Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, laptop computers, tablet computers, automobiles or other vehicles, or drones or other aircraft. Another example of a UE may be a virtual reality/extended reality appliance 117, such as smart glasses, a virtual reality headset, an augmented reality headset, and other similar devices that may provide images, video, audio, touch sensation, taste, or smell sensation to a wearer. A UE, such as XR appliance 117, may transmit or receive wireless signals with a RAN base station 105 via a long-range wireless link 125, or the UE/XR appliance may receive or transmit wireless signals via a short-range wireless link 137, which may comprise a wireless link with a UE device 115, such as a Bluetooth link, a Wi-Fi link, and the like. A UE, such as appliance 117, may simultaneously communicate via multiple wireless links, such as over a link 125 with a RAN base station 105 and over a short-range wireless link. XR appliance 117 may also communicate with a wireless UE via a cable, or other wired connection. An XR appliance 117 may offload processing functionality or functionality related to communicating with a RAN, to a user equipment 115, which may be referred to as an intermediate user equipment or an XR processing unit. An XR processing unit or a RAN, or a component thereof, may be implemented by one or more computer components that may be described in reference to FIG. 11. An XR processing unit may also comprise components described in reference to FIG. 12

Continuing with discussion of FIG. 1, base stations 105, which may be referred to as radio access network nodes or cells, may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one component carrier, or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications, such as sidelink communication, may be within the geographic coverage area 110 of a base station 105. Other UEs 115 in such a group may be outside the geographic coverage area 110 of a base station 105 or be otherwise unable to receive transmissions from a base station 105. In some examples, groups of

UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both. In FIG. 1, vehicle UE 116 is shown inside a RAN coverage area and vehicle UE 118 is shown outside the coverage area of the same RAN. Vehicle UE 115 wirelessly connected to the RAN may be a sidelink relay to in-RAN-coverage-range vehicle UE 116 or to out-of-RAN-coverage-range vehicle UE 118.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communication system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Core network 130 may comprise, or may be communicatively coupled with, shared core entity 131, which may be referred to as a shared core entity node or a shared core node. Shared core entity 131 may be associated with TN node 105 or NTN node 107 and may facilitate unified interfacing among TN node 105, NTN node 107, and elements of core network 130. For example, TN node 105 and NTN node 107 may not be configured to communicate directly with one another due to different communication protocols due to absence of direct communication links therebetween, due to configuration incompatibility (e.g., NTN satellite node 107 and TN RAN node 105 being operated by different entities that have declined to configure equipment corresponding to the different entities to interoperate with each other), or due to other reasons. Accordingly, shared core entity 131 may be configured to facilitate joint scheduling, joint interference detection, joint operation of coordination algorithms, or other joint operations between RAN node 105 and NTN node 107. Shared node 131 may facilitate maintaining of user equipment information privacy with respect to RAN node 105 or NTN node 107 that may be operated by a different operator or service provider than an operator or provider with which the user equipment is subscribed to operate. Shared core entity 131 may facilitate executing software instructions that may be provided by an entity other than an operator of NTN node 107 or TN RAN node 105, and thus may facilitate efficient TN-NTN system integration without private terrestrial network information being shared with a non-terrestrial network, and vice versa.

Core network 130 may comprise, or may be communicatively coupled with, extended reality server 132. XR server 132 may facilitate generating traffic responsive to traffic transmitted by an appliance 117. The less time between an appliance 117 generating traffic and server 132 receiving and transmitting to the appliance traffic that is responsive to the traffic transmitted by the appliance the better a user of the appliance will perceive an experience corresponding to use of the appliance.

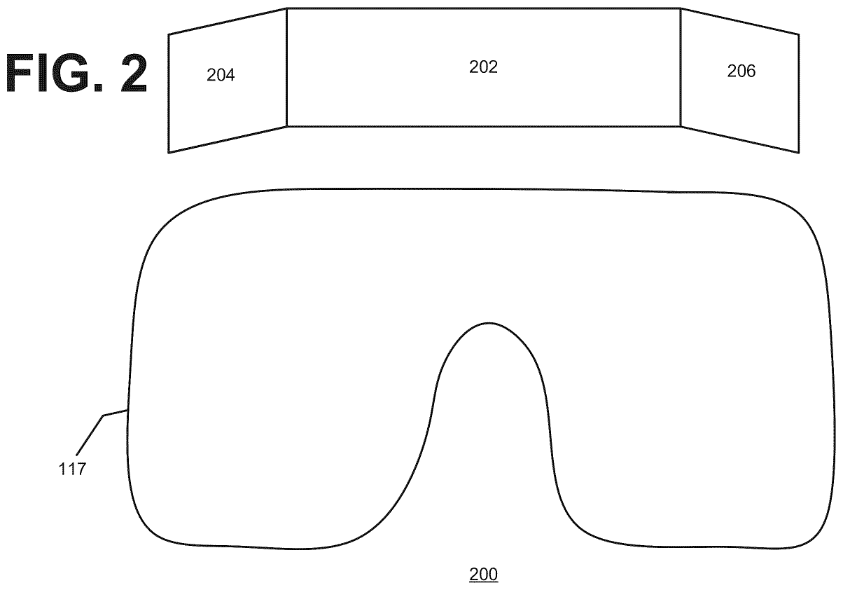

Turning now to FIG. 2, the figure illustrates a virtual reality (“VR”) application system 200. In system 200, wearable VR appliance 117 is shown from a wearer's, or viewer's, perspective. VR appliance 117 may comprise a center, or pose, visual display portion 202, a left visual display portion 204 and a right visual display portion 206, that may be used to display main visual information, left peripheral visual information, and right peripheral visual information, respectively. As shown in the figure, the portions 202, 204, and 206 are delineated by distinct lines, but it will be appreciated that hardware or software may facilitate gradual transition from main and peripheral information display.

As discussed above, different XR use cases may require different corresponding radio performance. Typically, for XR use cases but unlike for URLLC or eMBB use cases, high-capacity radio links that carry XR data traffic (e.g., data flows that comprise visual information) with stringent radio levels (e.g., latency) and reliability levels are required for a reasonable end user experience. For example, compared to a 5 Mbps URLLC link with a 1 ms radio latency budget, some XR applications require 100 Mbps links with about 2 mS allowed radio latency.

From research, several characteristics have been determined with respect to XR data traffic: (1) XR traffic characteristics are typically periodic with time-varying packet size and packet arrival rate; (2) XR capable devices (e.g., smart glasses, projection wearables, etc.) may be more power-limited than conventional mobile handsets, due to the limited form factor of the devices; (3) multiple data packet flows corresponding to different visual information of a given XR session are not perceived by a user as having the same impact on the end user experience.

Thus, in addition to needing XR-specific power use efficiency, smart glasses, such as wearable appliance 117, streaming 180-degree high-resolution frames requires broadband capacity for providing an optimum user experience. However, it has been determined that data corresponding to the frames that carry main, or center visual information (i.e., the pose or front direction) are the most vital for end user satisfaction, while the frames corresponding to peripheral visual information have a lesser impact on a user's experience. Therefore, accepting higher latency for less important traffic flows so that resources that would otherwise be allocated to the less important traffic flows can be used for traffic flows corresponding to more important traffic, or to devices that carry the more important traffic, may be used to optimize overall capacity and performance of a wireless communication system, such as a 5G communication system using NR techniques, method, systems, or devices. For example, a wireless data traffic flow carrying visual information for display on center, or pose, visual display portion 202 may be prioritized higher than a wireless data traffic flow carrying visual information for left visual display portion 204 or for right visual display portion 206.

The performance of a communication network in providing an XR service may be at least partially determined according to satisfaction of a user of the XR services. Each XR-service-using user equipment device may be associated with certain QoS parameter criterion/criteria with respect to which measured values, or metrics, corresponding to traffic flows that facilitate XR service may be analyzed. Adjusting scheduling of traffic such that a measured traffic flow metric satisfies a QoS parameter, such as, for example, a data rate, an end-to-end latency, or a reliability may be beneficial to a user's XR experience.

A 5G NR radio system typically comprises a physical downlink control channel (“PDCCH”), which may be used to deliver downlink and uplink control information to cellular devices. The 5G control channel may facilitate operation according to requirements of URLLC and eMBB use cases and may facilitate an efficient coexistence between such different QoS classes.

In an embodiment, a user equipment may be deployed as an extended reality processing unit and may facilitate communication with a RAN node on behalf of a less capable end XR appliance (e.g., less capable in terms of processing power, battery capacity, transmitter power, or the like). An extended reality processing unit may comprise an ‘in-box’ processing unit/device that facilitates signaling, traffic handling, and overall radio assistance to an end XR appliance (e.g., helmets, or glasses), which may be capable of communicating directly with a RAN node but with reduced capability. Accordingly, an XR processing unit, which may be referred to as an intermediate XR processing unit, (e.g., a laptop, a smartphone, or other computing device that can communicate with a RAN node 105, that can communicate with one or more appliances 117, and that is intermediate with respect to communication links between a RAN node and an end XR appliance) may facilitate relaxing a large subset of radio functions and operations, traffic processing, and battery consumption load with respect to an end XR appliance thus leading to a more efficient end XR appliance device design (e.g., requiring less battery size, dissipating less heat, etc.).

XR applications may benefit from highly dynamic and ultra-fast radio adaptation procedures determined not just with respect to radio conditions of an XR appliance but also with respect to user (e.g., human) reactions or interaction with respect to XR applications. According to conventional techniques, an XR appliance may need to frequently request, from a serving RAN node, re-configuration updates of radio settings that match real-time, variable, XR device behavior and human behavior. For example, an XR appliance may be preconfigured with a certain scheduled resource set and may frequently request scheduling resource updates based on highly-varying traffic volume generated by an XR application executed by the XR appliance, thus leading to a problem of increased radio control signaling overhead in addition to increased delay in reaction to sudden XR device behavioral changes (e.g., device behavior changes or user behavior changes).

Example embodiments described herein may provide solutions to problems existing with current techniques by facilitating proactive, low-signaling-overhead configuration adaptation procedures that may facilitate fast radio configuration adaptation for XR applications and minimize control radio signaling overhead by avoiding repetitive exchanging via radio interface link(s) of radio setting configuration requests and corresponding updates via radio interface link(s). For example, according to example embodiments disclosed herein, an intermediate/master processing unit (e.g., an artificial intelligence-enabled laptop computer) may be configured, by a RAN node, with a set of configuration blocks, wherein each configuration block indicates, corresponds to, or is associated with, a predetermined set of radio settings (e.g., the radio settings may comprise a configured grant resource size, a resource periodicity, per-traffic flow transmission modulation and coding information, traffic payload repetition settings with respect to latency or reliability of critical traffic flows, and the like). Multiple configuration blocks, described in reference to example embodiments disclosed herein, may be designed, or determined by a RAN node, to match likely possibilities of behavior (e.g., behavior corresponding to an XR appliance and a human user thereof) that may be derived from a baseline XR service class that may be indicated to the RAN node by a connection establishment request corresponding to the XR appliance.

According to one or more example embodiments described herein, an intermediate/master XR processing unit may perform predictive local configuration adaptation of a configuration block of multiple configuration blocks, indicated to the XR processing unit by the RAN node, with respect to each of one or more end/slave XR appliance devices (e.g., XR glasses) associated with the processing unit. Thus, radio setting configurations may be rapidly adapted to real-time needs of an actual XR application because the XR processing unit determines and assigns a configuration block locally without requesting an updated radio setting configuration from the RAN node via an uplink message, without waiting for scheduling of radio setting configuration information by the RAN node, and without waiting for radio settings that are scheduled by the RAN to be indicated to the XR processing unit or an XR appliance via a downlink message. In one example embodiment, such local adaptation can be completely transparent to the serving RAN node without inflicting any uplink signaling overhead, but increased processing overhead of the more capable RAN node may occur due to the RAN node performing exhaustive blind decoding according to all possible configuration block variants that the RAN node indicated to the XR processing unit. In another example embodiment, local radio setting configuration adaptation can be non-transparent to the serving RAN node wherein the controlling intermediate processing unit may report to the RAN node, via an adaptation report, configuration block(s) that have been activated/assigned to end XR appliance device(s), which may result in reducing, compared to transparent mode, detecting and decoding processing overhead at the receiving RAN node although additional radio link resources may be used to transmit, from the XR processing unit to the RAN node, the configuration block adaptation report.

### Device-Driven Proactive Radio Configuration Adaptation

According to example embodiments disclosed herein, a RAN node may receive a binary artificial intelligence (“AI”) capability indication from a master/intermediate XR processing unit, wherein such binary indication may be indicative of a capability of the XR processing unit to execute predictive radio configuration adoption locally with respect to one or more end/slave XR appliance devices. A capability of the intermediate XR processing control unit to predict (and proactively report back to the serving RAN node) a configuration block assigned to a target slave/end XR appliance device may facilitate predicting near-future device behavior or user behavior corresponding to an XR appliance. A RAN node may establish, or determine, for example from information received from an XR server, a respective quality-of-service (“QoS”) profile for end XR appliance devices that corresponds to default behavior associated with an active XR application being executed by an XR appliance. However, due to varying human user behavior, corresponding to an end/slave XR appliance device, that the RAN not is not typically aware of, a new QoS profile and corresponding radio configuration block that best matches, or corresponds to, the new/updated QoS profile, may be timely adopted. Thus, a capability of an XR processing unit to predict real-time or near-future behavior (e.g., device behavior, radio channel behavior, or user behavior) corresponding to an end/slave XR appliance device may facilitate increased RAN efficiency by moving adaptation of radio settings and scheduling of resources with respect to an end/slave XR appliance devices from the RAN node to being performed locally by the intermediate/master XR processing unit and implemented locally with respect to the appliance(s) via short-range wireless link, thus reducing control channel traffic transmitted or received via a long range wireless link. Accordingly, a RAN node may configure a master/intermediate XR processing unit with one or more configuration blocks that match various states or behaviors corresponding to an active XR application being executed by an end/slave XR appliance device and the intermediate XR processing unit may determine a configuration block and corresponding radio settings be used to transmit traffic generated by the XR appliance.

In an example embodiment, a configuration block corresponding to a frequent, pre-scheduled, small-sized radio resource set may be suitable for applications/services that generate small but frequent latency-critical packets. According to an example embodiment, on condition of a transparent configuration block adaptation and an active session of one or more indicated end/slave devices, a RAN node may receive and attempt blind decoding of received traffic using all possibilities of all configuration blocks configured to the XR processing unit. Using transparent mode implementation may result in avoiding configurational control overhead traffic via radio interface link(s) but may result in the serving RAN node attempting multiple blind detection and decoding procedures, wherein each procedure corresponds to each of the pre-configured configuration blocks. The RAN node may have to attempt decoding according to each of multiple configured configuration blocks (at least until an attempt to decode traffic results in a successful decoding of received traffic) because the RAN node is not aware, according to transparent mode, of which modulation and coding scheme the XR processing unit has adopted for transmission of traffic generated by an XR appliance.

In another example embodiment, on condition of a non-transparent configuration block adaptation, wherein a RAN node is made aware of a master/intermediate XR processing unit decision/determination/adaptation with respect to which a configuration block is adopted/assigned for delivery of traffic generated by an end/slave XR appliance device, a RAN node may receive a time-bound configuration adaptation report, in the uplink direction from the master/intermediate XR processing unit. An adaptation report may comprise one or more end/slave XR appliance identifiers and one or more indication(s) of one or more active/adapted configuration block(s) respectively corresponding to one or more slave XR appliances. An adaptation report may comprise a validity period indication indicative of an active configuration block corresponding to an XR appliance. Thus, by using non-transparent local configuration adaptation, an XR processing unit may notify a RAN node regarding radio configuration block determinations made by the intermediate processing unit. Even though the reporting, according to a non-transparent mode, of the assignment of a configuration block for delivery of traffic corresponding to a particular XR appliance may consume uplink radio resources, by determining locally, with respect to an XR appliance, a configuration block to be used for delivery of traffic corresponding to the XR appliance, frequent uplink measurements reporting and reactive downlink reconfiguration messaging is avoided that would otherwise be needed according to conventional techniques.

According to conventional techniques, radio configurations corresponding to user equipment, including XR appliances, are adapted by a RAN node. Periodically, or when radio or non-radio conditions vary at a served user equipment, a user equipment triggers/transmits an uplink radio signal message or an application signaling message to the RAN node to receive updated radio setting information corresponding to a changed state of the user equipment or changed state of radio conditions. Thus, according to conventional techniques, a RAN node determines a change to/of radio configuration settings and an updated radio setting configuration determined by a RAN node triggers a transmitting, via downlink control channel signaling, reconfiguration information. Conventional techniques thus require back and forth uplink and downlink control channel signaling.

Example embodiments disclosed herein avoid back and forth uplink and downlink control channel signaling needed to implement conventional techniques. Instead of conventional back and forth uplink and downlink control channel signaling, example embodiments disclosed herein move the decision of adapting radio setting configurations from being performed at a RAN node to being performed locally with respect to a user equipment/XR appliance, thus avoiding bidirectional signaling overhead via long-range wireless radio links. Furthermore, compared to existing/conventional radio adaptation procedures, performing radio setting configuration adaptation locally results in faster adaptation of radio setting in response to user behavior caused by action of a user of an XR appliance.

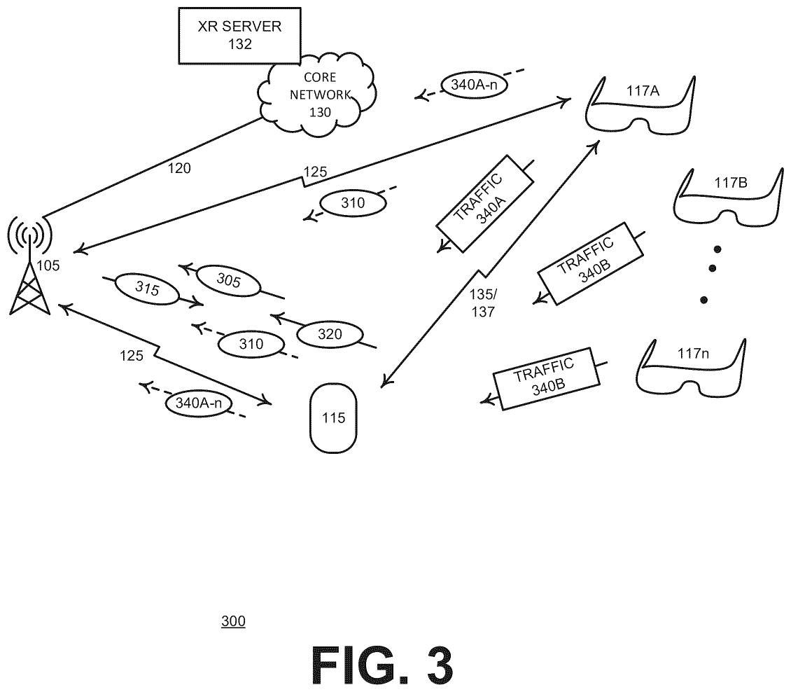

Turning now to FIG. 3, the figure illustrates an example environment 300 with an extended reality appliance 117 tethered to an intermediate extended reality processing unit user equipment 115. Appliance 117 may be referred to as an end XR appliance in reference to the relationship of being at an end of a communication session, with respect to RAN node 105, with extended reality processing unit 115 being located intermediate to the RAN node and the appliance. In an example embodiment, RAN node 105 may comprise a terrestrial radio network node. In an example embodiment, RAN node 105 may comprise a non-terrestrial radio network node. RAN XR processing unit 115 may be more capable with respect to battery capacity (or may be supplied power via a wired power supply receiving power from an electrical wall outlet), or with respect to processing capability, than XR appliance 117. In an embodiment, a downlink traffic flow providing traffic to a peripheral portion 204/206 (shown in FIG. 2) of VR/XR appliance 117 may be related to a downlink traffic flow carrying traffic to be displayed by a pose portion 202 of the appliance. In another example, two different traffic flows may respectively carry traffic directed to right side 202R and left side 202L of pose portion 202 and thus may be related. In another example, an uplink traffic flow may carry traffic related to a downlink traffic flow or downlink traffic flow may carry traffic related to an uplink traffic flow.

Facilitating extended reality services via cellular wireless communications may negatively impact spectral efficiency or energy consumption at RAN nodes or user equipment due to stringent combined requirements regarding capacity, latency, and reliability, one or more of which may tend to impose contradictory requirements with respect to one or more of the other requirements. For example, to facilitate capacity and video rendering requirements corresponding to many XR applications, advanced multi-antenna system, sophisticated processing, and larger battery capacities may be used at end XR devices/appliance, which may cause an increase in weight and heat generated and may detract from appearance of an end XR device/appliance (e.g., XR glass, helmet, or bracelet, etc.).

Deployment of a high-capability (with respect to an XR appliance 117) intermediate XR processing unit 115 between RAN node 105 and an XR appliance processing unit may facilitate relaying part of, or all of, XR radio traffic to or from the end XR device/appliance 117, thus reducing radio burden from the end XR appliance and facilitating the XR appliance being lower capability and lower weight than if the XR processing unit is not available to facilitate relaying of XR traffic between the appliance and RAN node. Burdens that may be offloaded from an end XR appliance 117 to intermediate XR processing unit 115 may comprise, for example, local traffic storage, processing of heavy control channel decoding, XR local video rendering, or advanced radio antenna manipulation. Thus, advanced receiver and processing capability may be facilitated for critical XR services with respect to an XR appliance 117, which may be lighter, more aesthetically pleasant, and more efficient than if the end XR appliance is not designed with capability to offload the burdens to intermediate XR processing unit 115.

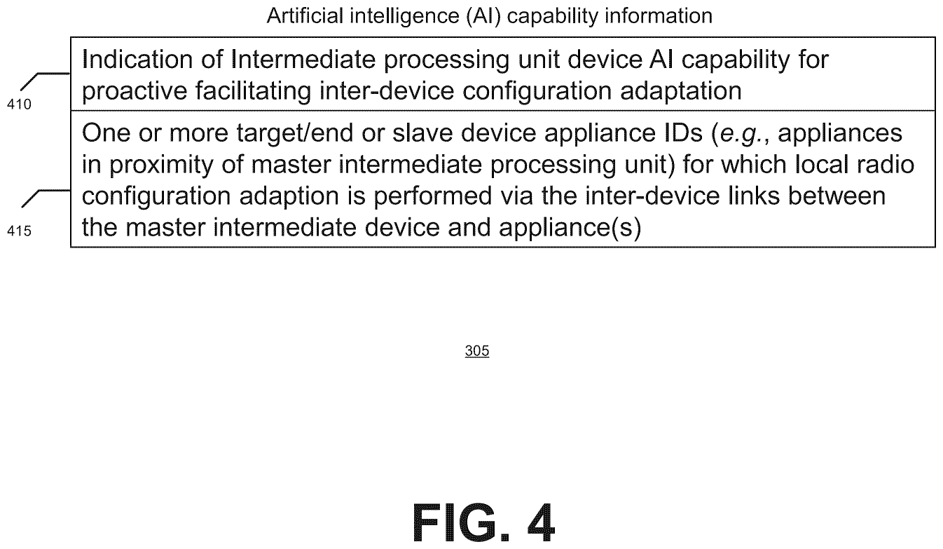

RAN node 105 may receive, via uplink radio interface link(s) 125 from extended reality (XR) intermediate/master device 115, which may comprise multi-traffic-profile capability, an artificial intelligence (AI) capability information message 305, which may be referred to as a configuration block capability indication message. Configuration block capability indication message 305 may be indicative that XR processing unit 115 is configured to facilitate operation of at least one XR appliance 117A-117n according to at least one radio configuration, which may be selectable by the XR processing unit based on at least one user equipment characteristic corresponding to at least one of the appliances 117. In field 410, shown in FIG. 4, message 305 may comprise at least one of a true indication that XR processing unit 115 is capable of handling, or facilitating, proactive inter-device configuration adaptation (e.g., a one-bit indication the XR processing unit may determine, or select, one of multiple configuration profiles received from RAN 105 for use in delivering of uplink traffic transmitted by one or more appliances 117 toward RAN 105). The traffic may be delivered according to radio settings indicated by a determined/selected configuration block directly from an appliance 117 to RAN 105 or traffic may be delivered according to radio settings indicated by a determined/selected configuration block from an appliance 117 to RAN 105 via XR processing unit 115. XR processing unit 115 may transmit uplink traffic, received from an appliance 117, to RAN 105 according to radio settings indicated by a determined/selected configuration block.

In field 415, shown in FIG. 4, message 305 may comprise one or more identifiers respectively associated with one or more appliances 117A-117n that may be in close proximity of master XR processing unit 115 (e.g., within range of a short-range wireless link 135 or 137, for example a Wi-Fi or Bluetooth link). XR processing unit 115 may perform local radio setting configuration adaptation with respect to one or more appliances 117A-117n.

Message 305 may facilitate serving RAN node 105 being made aware that XR processing unit 115 is capable of adapting different radio setting configurations locally with respect to connected slave/end appliance devices 117 or that such adaptation may be facilitated by at least on artificial intelligence learning model. Adapted radio configuration settings corresponding to a selected/determined configuration block may be used by an appliance 117 or by XR processing unit 115 to deliver uplink traffic generated by an appliance 117 without the processing unit or without one of the appliances requesting, from RAN 105, resources and without the RAN scheduling requested resources and then transmitting a downlink message indicative to the processing unit or appliance(s) of scheduled resources and corresponding decoding information.

Message 305 may be indicative that processing unit 115 may be capable of predicting, or may be configured to predict, a configuration block comprises radio settings to be used by an appliance to transmit traffic to RAN 105 based on user behavior corresponding to use of an appliance 117. One or more artificial intelligence learning model(s) configured within intermediate processing unit 115 may utilize generative artificial intelligence techniques to proactively predict a configuration block. The artificial intelligence model(s) may be trained based on a variety of data sources that may comprise historical network performance data (e.g., performance with respect to a radio link 125), real-time traffic flow metrics, device behavior patterns with respect to an appliance 117, or predictive user behavior model information. By analyzing training data and information, one or more artificial intelligence models configured or installed in XR processing unit 115 may be able to identify trends, patterns, and potential future demands with respect to radio parameters corresponding to one or more radio link(s) 125.

Continuing with description of FIG. 3, RAN node 105 may receive one or more connection establishment requests 310, via an uplink interface link 125, indicating one or more source device identifiers corresponding to one or more appliances 117 that may have been indicated via field 415 in message 305 as being configured for local radio configuration adaptation. Connection establishment requests 310 are shown in FIG. 3 with dashed lines to indicate that requests 310 may be received from XR processing unit 115 or directly from one or more appliance(s) 117. A connection establishment request 310 may comprise a service cause indication indicative of a service, an application, a quality of service, a quality level, or other user equipment characteristic corresponding to the one or more appliance(s) 117 with respect to which requests(s) 310 are received, and may be indicative of a request that RAN node 105 determine one or more radio configuration blocks corresponding to the appliances as indicated by the one or more connection establishment requests 310. A configuration information block may comprise a set of radio configurations respectively associated with a set of radio parameter settings that may be tailored to facilitate a traffic behavior, user behavior, and/or radio condition as indicated by a connection establishment request 310. For example, a configuration block of frequent, pre-scheduled, and small-sized radio resources may be suitable for applications/services that generate small but frequent latency-critical traffic packets.

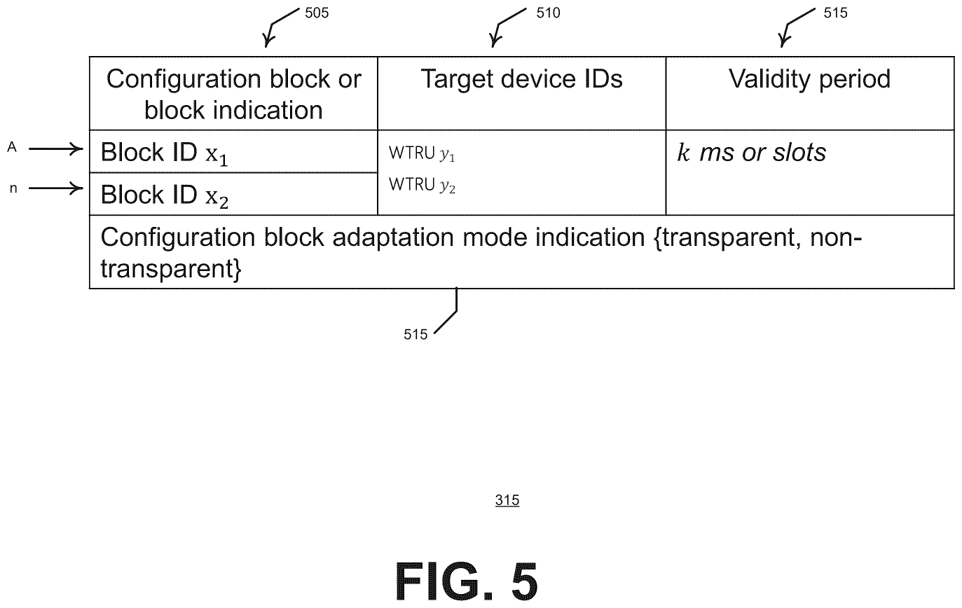

RAN node 105 may transmit, in the downlink radio direction towards master/intermediate XR processing unit 115, a configuration block information message 315, which may be referred to as a configuration block message. Message 315 may comprise at least one configuration block indication indicative of at least one radio configuration set or radio settings. Message 315 may comprise in field(s) 505, shown in FIG. 5, one or more configuration blocks, or configuration block indications. In field(s) 510, message 315 may comprise one or more identifiers associated with one or more XR appliances 117 with respect to which the indicated configuration blocks are associated. In one or more fields 520, message 315 may indicate a validity period during which one or more configuration blocks indicated in one or more fields 505A-505n are to be active. Upon expiration of a validity period, XR processing unit 115 or appliance(s) 117 may operate as if local configuration adaptation by the XR processing unit is not applicable and revert to conventional resource scheduling procedures.

In field 515, message 315 may comprise an indication of a configuration block adaptation mode as being a transparent mode or a non-transparent mode. For example, a transparent configuration block adaptation mode may be indicative that radio settings corresponding to a configuration block used to deliver to RAN node 105 traffic 340 (shown in FIG. 3) generated by an XR appliance 117 at the end XR appliance 117 are transparent to the RAN node insofar as RAN node 105 is not made aware of a configuration block, indicated in field 505, that intermediate processing unit 115 has selected for delivery of traffic 340 to the RAN node, thus resulting in the RAN node performing blind decoding of received traffic 340. Blind decoding is undesirable insofar as processing and detection processing is increased but is desirable insofar as radio signaling overhead is reduced (e.g., XR processing unit 115, or an appliance 117, does not transmit an uplink message indicative of a configuration block that comprises radio setting indications indicative of radio settings used to transmit traffic 340).

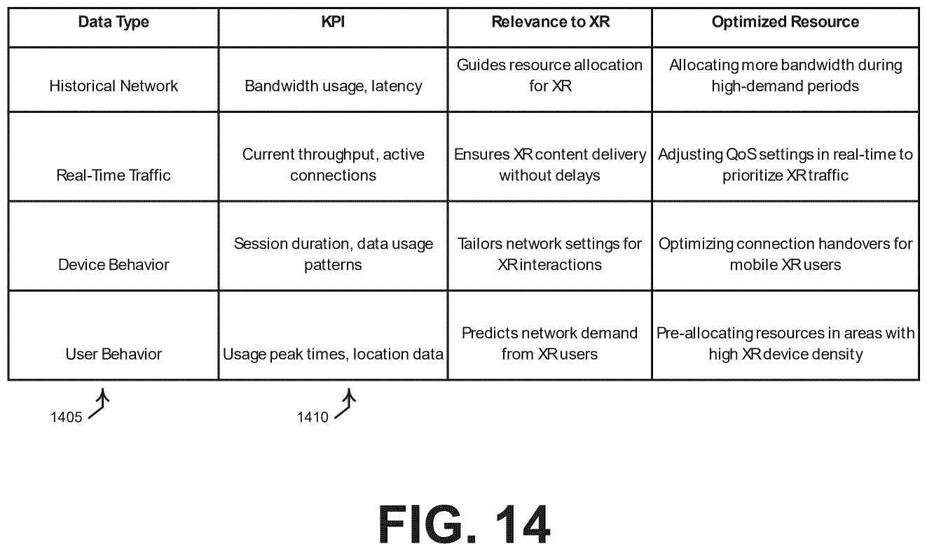

If message 315 indicates transparent configuration block adaptation mode and if active communication session has been established by RAN node 105 with respect to one more appliance(s) 117, RAN node may receive and attempt blind decoding of traffic 340 transmitted by the appliance(s) using all possibilities of all frequency and time resources and all modulation and decoding information corresponding to all configuration blocks indicated in message 315. Such transparent mode avoids configurational control overhead being transmitted via radio link(s) 125 but typically may result in serving RAN node 105 attempting multiple blind detection and decoding operations wherein each detection and decoding attempt is performed according to resource, modulation, and decoding information corresponding to each configuration block configured via message 315 because the RAN node has not been made aware of which modulation and coding XR processing unit 115 may have determined/selected for use for delivery to the RAN node of traffic generated by the appliance(s). In an example embodiment, RAN node 105 may attempt blind decoding of received payload 340 based on a rules-based process. For example the RAN node may use a first modulation/coding scheme corresponding to a first configuration block indicated in message 315 (e.g., configuration block x₁ indicated in field 505A) and if decoding is unsuccessful according to the first configuration block, the RAN node may proceed to next attempt blind decoding according to a next modulation/coding scheme corresponding to a second configuration block indicated in message 315 (e.g., configuration block x₂ indicated by field 505n). In an example embodiment, RAN node 105 may attempt blind decoding of received payload 340 according to a determination, or prediction, made by the RAN of a configuration block that the XR processing unit is likely to select. The prediction/determination made by the RAN node may be facilitated by an artificial intelligence machine learning model that may be trained based on information similar to information shown in FIG. 14.

A transparent adaptation mode, indicated in field 520, may be indicative that adaptation of one or more configuration blocks, indicated in message 315, by XR processing unit 115 may be non-transparent with respect to RAN node 105. For example, if non-transparent configuration block adaptation is indicated in field 520, RAN node 105 may receive a time-bound configuration adaptation report 320, in the uplink direction from the master/intermediate device. Configuration adaptation report 320 may be referred to as a radio configuration adaptation report and may comprise at least one of: one or more identifiers respectively associated with one or more appliance(s) 117; one or more configuration block(s) respectively associated with the indicated appliance(s); and/or one or more selected configuration block validity period(s), determined by XR processing unit 115, respectively corresponding to selected configuration block(s) indicated by report 320.

RAN node 105 may receive and decode traffic transmitted by one or more appliances 117 according to resources associated with configuration blocks indicated in report message 320 as being determined by XR processing unit with respect to XR appliance(s) 117 indicated in report message 320. Accordingly, for non-transparent configuration block adaptation mode, blind decoding, by serving RAN node 105, is not needed, although signaling overhead may be slightly increased with respect to transparent mode insofar as network resources may be used by intermediate XR processing unit 115 to occasionally, or periodically, report back to RAN node 105 report message 320.

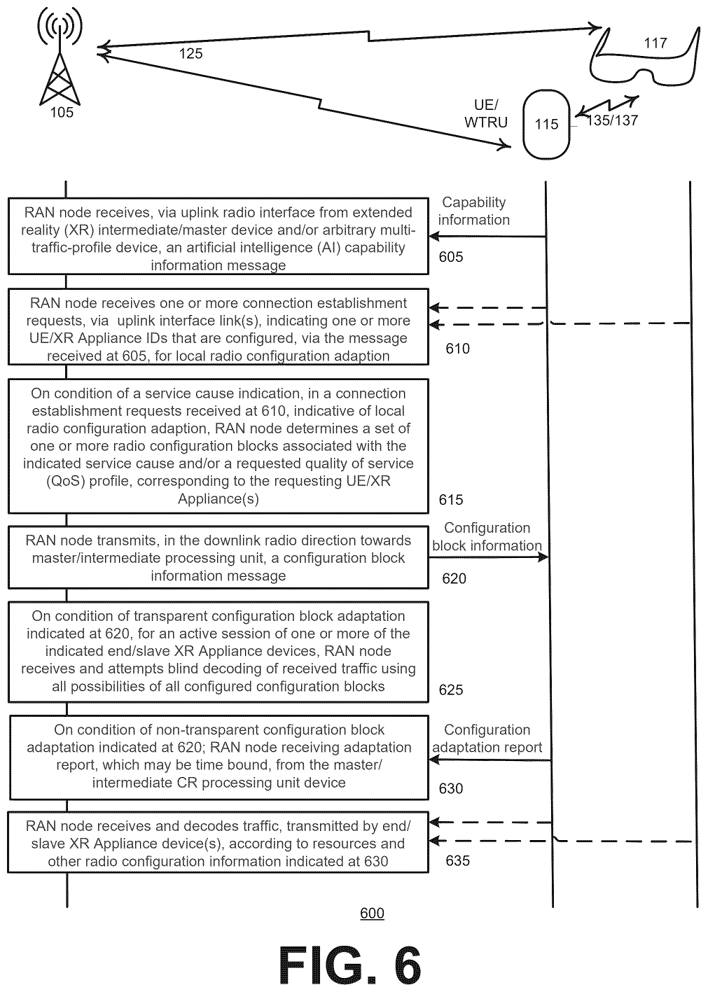

Turning now to FIG. 6, the figure illustrates a timing diagram of an example embodiment method 600 to facilitate radio network node 105 receiving traffic, that may have been transmitted by end XR appliance 117, according to radio settings corresponding to a configuration block determined, or selected, by intermediate processing unit 115. At act 605, RAN node 105 may receive via at least one uplink radio interface link(s) 125 from XR processing unit 115 or from an arbitrary multi-traffic-profile device, an artificial intelligence capability information message, such as message 305 described in reference to FIG. 3. The message received at act 605 may comprise an indication of AI capability with respect to XR processing unit 115 that the XR processing unit can proactively handle, or facilitate, inter-device configuration block prediction and adaptation. Proactive facilitation of inter-device configuration block/radio setting adaptation indicated at act 605 may comprise predicting, using one or more artificial intelligence models, user behavior of a user using an XR appliance 117. A message received at act 605 may comprise one or more identifiers of one or more target/end/slave XR appliance(s) 117 (e.g., one or more appliance(s) 117 within range of a short-range wireless link 135/137 with XR appliance 115, by which local radio configuration adaptation is to be facilitated via inter-device links 135/137).

At act 610, RAN node 105 may receive one or more connection establishment requests (e.g., request(s) 310 described in refence to FIG. 3), via an uplink interface link 125, from XR processing unit 115 or from one or more XR appliances 117. (The receiving of the requests at act 610 are shown in dashed lines to indicate that the request(s) may be received by RAN 105 from XR processing unit 115 or directly from appliance(s) 117.) Identifiers indicated in the one or more request(s) received at act 610 may correspond to, or may be, identifiers indicated in the message received at act 605 and may be indicative of appliances 117 respectively associated with the identifiers as being configured, by XR processing unit 115, for determination by the XR processing unit of configuration blocks and radio configuration settings respectively associated therewith.

Based on a service cause of, or a service indicate by, a connection establishment request received at act 610, at act 615 RAN node 105 may determine a set of radio configuration blocks associated with the indicated service and/or a quality-of-service profile indicated by, or corresponding to, a connection establishment request message. A configuration information block may comprise one or more indications of a set of one or more radio parameter settings that match traffic and user behavior and/or radio conditions that may correspond to a requested service or quality-of-service indicated by a connection establishment request. For example, a configuration block comprising at least one indication of a set of frequent, pre-scheduled, small-sized radio frequency and time resources may be suitable for an application being executed by, or services being facilitated by, appliance 117, as indicated in a request corresponding thereto received by RAN 105 at act 610, that tend to generate small and frequent latency-critical packets.

At act 620, RAN node 105 may transmit, in the downlink radio direction via link(s) 125 toward master/intermediate XR processing unit 115, a configuration block information message (e.g., message 315 described in reference to FIG. 3) that may comprise at least one of: one or more configuration blocks or configuration block indications, at least one identifier associated with an XR appliance 117 with respect to which the indicated configuration block(s) is/are associated with, or an adaptation mode indication in terms of transparent or non-transparent adaptation. A message transmitted at act 620 may comprise one or more validity period(s), or one or more validity period indication(s), indicative of one or more respective period(s) during which corresponding configuration blocks are to be active, or usable by XR processing unit 115 to select for use in transmitting traffic generated by one or more appliances 117.

According to a transparent configuration block adaptation mode indication, a configuration block determined by XR processing unit for delivery of traffic generated by at least one appliance 117 may be transparent, or unknown, to RAN node 105. Transparent configuration block adaptation mode may lead to increased processing and detection processing with respect to non-transparent mode but with reduced radio signaling overhead.

On condition of transparent configuration block adaptation being indicated by the message transmitted at act 620 and based on an active session having been established between RAN node 105 and an appliance 117, at act 625 the RAN node may receive traffic transmitted by the appliance and may attempt blind decoding of the received traffic using all possibilities corresponding to all configured configuration blocks configured via the message transmitted at act 620 with respect to the appliance.

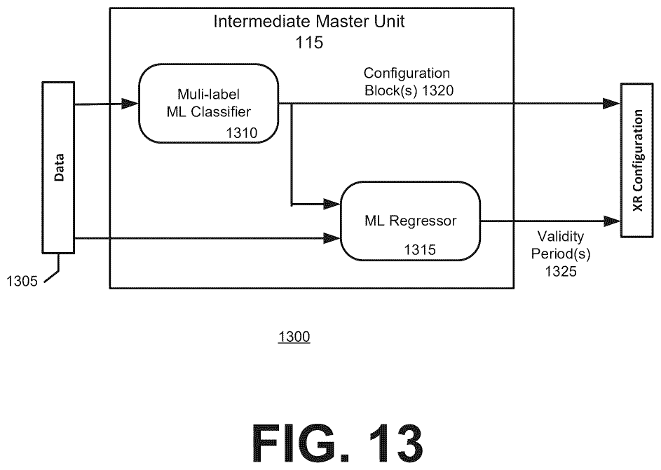

On condition of non-transparent configuration block adaptation being indicated by the message transmitted at act 620, at act 630 RAN node 105 may receiving a time-bound configuration adaptation report (e.g., a radio configuration adaptation report 320 shown in FIG. 3) in the uplink direction from master/intermediate XR processing unit 115. The message received at act 630 may be indicative of at least one determined radio configuration of the at least one radio configuration. The message received at act 630 may comprise at least one identifier associated with at least one appliance 117. The message received at act 630 may comprise an indication of at least one configuration block, selected from at least one configuration block indicated in the message transmitted at act 620, that XR processing user 115 has associated with each at least one appliance 117 indicated in the message received at act 630. The message received at act 630 may comprise a validity period corresponding to the at least one indicated configuration block per appliance 117. (The validity period may be determined by XR processing unit 115 as described in reference to FIG. 13 and is different than a validity period that may be indicated in message 315 transmitted to the XR processing unit at act 620). At act 635, based on non-transparent mode being indicated in the message transmitted at act 620, RAN node 105 may receive and decode traffic, transmitted by at least one appliance 117, according to active resources corresponding to at least one configuration block indicated in the message received at act 630 respectively associated with at least one appliance 117 indicated in the message received at act 630.

FIG. 13 illustrates an example embodiment of artificial intelligence machine learning models that may be used by XR processing unit 115 to determine at least one configuration block with respect to which radio configuration settings associated therewith are to be used by and XR appliance says 117. XR processing unit 115 may predict user behavior, or other characteristics, corresponding to an end XR appliance 117 to facilitate the determining of a configuration block with respect to which radio settings corresponding thereto are to be used to deliver traffic to a RAN node 105. At least one artificial intelligence learning model may operate to dynamically configure radio settings that may be used to facilitate delivery of XR traffic. Multi-label machine learning model classifier 1310 may process information 1305 corresponding to one or more data types 1405 (shown in FIG. 14), for example network information, traffic information, device information, or user behavior information, to predict, or to determine, one or more configuration blocks 1320, identifiers thereof, or indications thereof, that that may comprise, or that may be indicative of, radio setting values, or indications thereof. A configuration block 1320 may be predicted/determined before an appliance 117 generates traffic to be associated with the predicted/determined configuration block, or blocks, thus facilitating adaptation of delivery of generated traffic according to optimized radio settings (e.g., radio settings corresponding to a configuration block, predicted/determined from one or more configuration block(s)/indication(s) received in a message 315 from RAN 105) without XR processing unit 115, or an XR appliance 117, having to request from the RAN node and wait for an indication from the RAN node of resources that are tailored, assigned, or scheduled to facilitate delivery of the generated traffic.

In an example embodiment, artificial intelligence machine learning model regressor 1315 may analyze the same data as analyzed by classifier 1310 as well as determined configuration block information 1320 to determine at least one validation period(s) 1325. (A validation period 1325 is different than a validation period that may be indicated in field 520 of message 315). It will be appreciated that classifier 1310 or regressor 1315 typically generate one configuration block prediction/determination 1320 or one corresponding validity period 1325 per iteration of the classifier or regressor models. In an example embodiment, classifier 1310 or regressor 1315 may determine more than one configuration block or corresponding validity period based on data/information 1305. A determined validation period 1325 may facilitate enhanced reliability and effectiveness of radio settings corresponding to a configuration block determined using classifier 1310. For example, if a configuration block determined by classifier 1310 does not comprise or indicate radio settings that are optimal for traffic being generated by an XR appliance 117 to which the determined configuration block corresponds, use of the non-optimal radio settings corresponding to the determined configuration block may be limited in duration based on expiration of a validity period 1325 determined by the ML regressor. Outputs of models 1310 or 1315 may define an XR configuration in terms of a determined configuration block 1320 or a determined validity period 1325 corresponding to a determined configuration block.

FIG. 14 illustrates various types of information that may be usable by models 1310 or 1315 described in reference to FIG. 13. An XR processing unit 115 may be capable of utilizing various data types 1405 to optimize network performance, with respect to at least one radio link 125, corresponding to delivery of traffic generated by an end XR appliance 117, by facilitating adaptation of one or more configuration blocks to traffic generated by, and to be transmitted by, the XR appliance. Determination and prediction by XR processing unit 115 of a configuration block to be used with respect to traffic generated or transmitted by an XR appliance 117 may be enhanced by analyzing both historical and real-time data, for example by focusing on bandwidth and quality-of-service adjustments. Insights gleaned by one or more models 1310 or 1315 of measured parameter values 1410 shown in FIG. 14 with respect to device behavior or network behavior corresponding to use of an appliance 117 or with respect to user behavior using an appliance 117 may facilitate proactive (e.g., predictive) tweaks to radio settings used to transmit traffic, generated by the appliance, based on determination of different configuration blocks corresponding to predicted behavior, thus promoting efficient network resource utilization (e.g., efficient use of one or more radio link(s) 125) and seamless XR experience perception and satisfaction with respect to a user of the XR appliance.

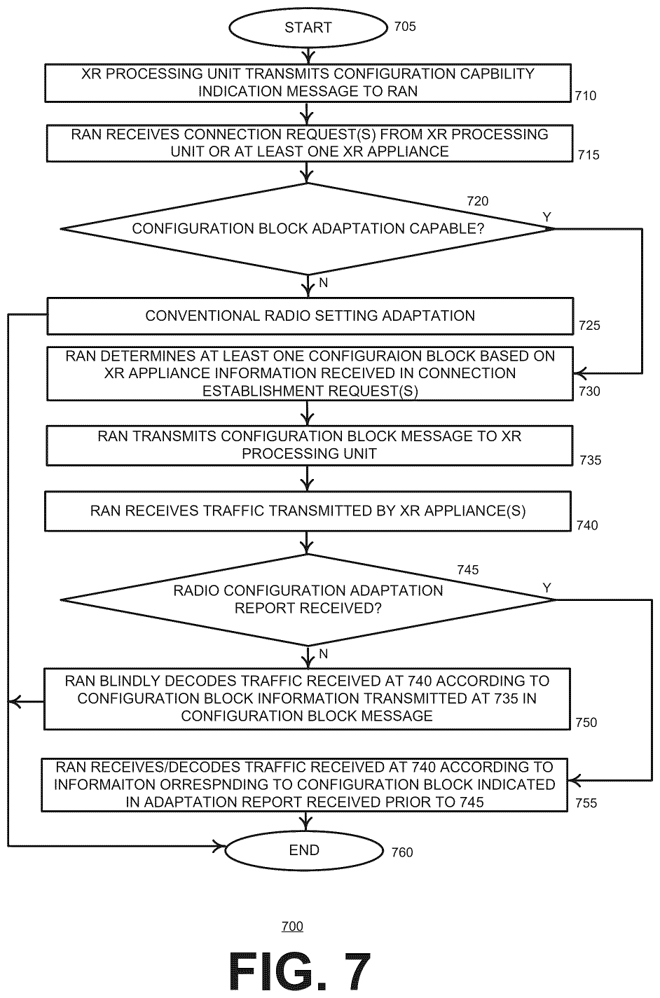

Turning now to FIG. 7, the figure illustrates a flow diagram of an example embodiment 700. Method 700 begins at act 705. At act 710, an XR processing unit may transmit a configuration capability indication message to a radio access network node. The configuration capability indication message may be indicative that the XR processing unit is capable of determining, or selecting, from among multiple configuration blocks, a configuration block indicative of radio settings that may be usable by an XR appliance to facilitate delivery of traffic transmitted by the XR appliance. At act 715, the radio access network node may receive at least one connection request from the XR processing unit or from at least one XR appliance that may be associated with the XR processing unit. For example, a group of XR appliances may be associated with the XR processing unit as a group that comprises XR appliances that are located within a short-range wireless signal range of the XR processing unit such that the XR processing unit may facilitate delivery of traffic between the XR appliances and the radio access network node. The radio access network node may receive at least one connection establishment request from at least one of the appliances or from the XR processing unit on behalf of at least one of the appliances.

At act 720, the radio access network node may determine whether a configuration capability indication associated with the XR processing unit or the group of XR appliances was received at act 710. If a determination is made at act 720 that a configuration capability indication message corresponding to the XR processing unit or the XR appliance group was not received at act 710, method 700 may advance to act 725. At act 725, the radio access network node may perform conventional radio setting adaptation procedures with respect to the XR processing unit or the XR appliances with respect to which the connection establishment request(s) received at 715 may correspond. Conventional radio setting adaptation procedures may comprise receiving periodic or event-triggered uplink channel scheduling requests and transmitting to the XR processing unit, or to the XR appliances, uplink resource scheduling messages. Method 700 may advance to act 760 and end.

Returning to description of act 720, if the radio access network node determines that a configuration capability indication corresponding to the XR processing unit was received at act 710 that is indicative that the XR processing unit is capable of determining, from among several configuration blocks, a configuration comprising radio resource indications usable to facilitate delivery of traffic generated by the XR appliance(s) that may have requested connection establishment at act 715, method 700 advances to act 730. At act 730, the radio access network node may determine at least one configuration block based on user equipment information, which may be referred to as radio characteristic information, or appliance characteristic information, that corresponds to at least one of the XR appliances with respect to which a connection establishment request was received at act 715 (e.g., the characteristics upon which the RAN node determines the at least one configuration block may comprise an application type, a quality of service, a user equipment capability, or other characteristic associated with the XR appliance(s) that may have requested connection establishment at act 715).

At act 735, the radio access network node may transmit a configuration block message, such as message 315 described in reference to FIG. 3 and FIG. 5, to the XR processing unit. The configuration block message may comprise the configuration blocks, or indications thereof, determined, or selected, at act 730. The configuration block message may comprise one or more identifiers, corresponding to the XR appliances that may have requested connection establishment at act 715, associated with the configuration blocks determined at act 730. The configuration block message transmitted at act 735 may comprise a validity period indication indicative of an activation period during which the XR processing unit may assign a configuration block, and radio settings corresponding thereto, to deliver of traffic generated by and XR appliance and directed to the radio access network node. The validity period may limit how long the configuration blocks are available for assigning to delivery of traffic generated by an XR appliance to limit use of the configuration block in case an artificial intelligence learning model, used to determine or select a configuration block to facilitate delivery of XR appliance traffic, becomes unstable or otherwise determines a suboptimal configuration block. The configuration block message may comprise a configuration block adaptation mode indicative of a transparent adaptation mode or a non-transparent adaptation mode.

At act 740, the radio access network node may receive traffic transmitted by one or more XR appliance(s). The traffic received at act 740 may be received directly from the one or more XR appliance(s) or the traffic may be received from the XR processing unit. At act 745, the radio access network node may determine whether a radio configuration adaptation report (e.g., report 320 describes in reference to FIG. 3) has been received from the XR processing unit. If a determination is made at act 745 that a radio configuration adaptation report has not been received, at act 750 the radio access network node may blindly decode the traffic received at act 740 according to configuration block information transmitted at act 735 in the configuration block message. After successfully determining radio settings (e.g., frequency and time resources, modulation scheme, or decoding information, etc.) to use to decode the traffic received at act 740, the radio access network node receives and decodes the traffic received at act 740 and method 700 ends at act 760.

Returning to description of act 745, if the radio access network node determines that a radio configuration adaptation report, indicative of a configuration block applicable to transmission of traffic, by the XR processing unit or an XR appliance, received at act 740 has been received, at act 755 the radio access network node may receive and decode the traffic received at act 740 according to information corresponding to a configuration block indicated in a configuration adaptation report received before act 745. Method 700 advances to act 760 and ends.

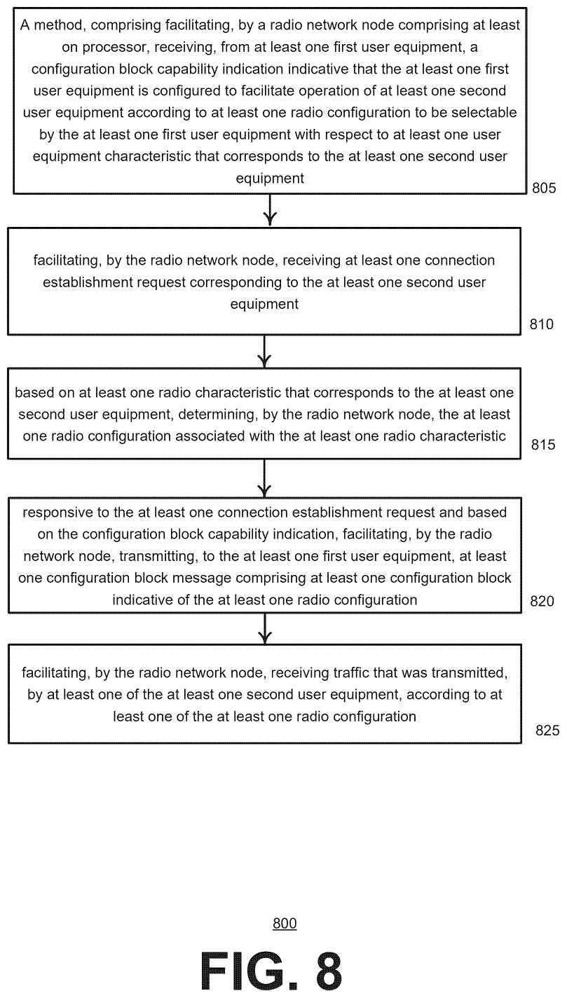

Turning now to FIG. 8, the figure illustrates an example embodiment method 800 comprising at block 805 facilitating, by a radio network node comprising at least on processor, receiving, from at least one first user equipment, a configuration block capability indication indicative that the at least one first user equipment is configured to facilitate operation of at least one second user equipment according to at least one radio configuration to be selectable by the at least one first user equipment with respect to at least one user equipment characteristic that corresponds to the at least one second user equipment; at block 810 facilitating, by the radio network node, receiving at least one connection establishment request corresponding to the at least one second user equipment; at block 815 based on at least one radio characteristic that corresponds to the at least one second user equipment, determining, by the radio network node, the at least one radio configuration associated with the at least one radio characteristic; at block 820 responsive to the at least one connection establishment request and based on the configuration block capability indication, facilitating, by the radio network node, transmitting, to the at least one first user equipment, at least one configuration block message comprising at least one configuration block indicative of the at least one radio configuration; and at block 825 facilitating, by the radio network node, receiving traffic that was transmitted, by at least one of the at least one second user equipment, according to at least one of the at least one radio configuration.

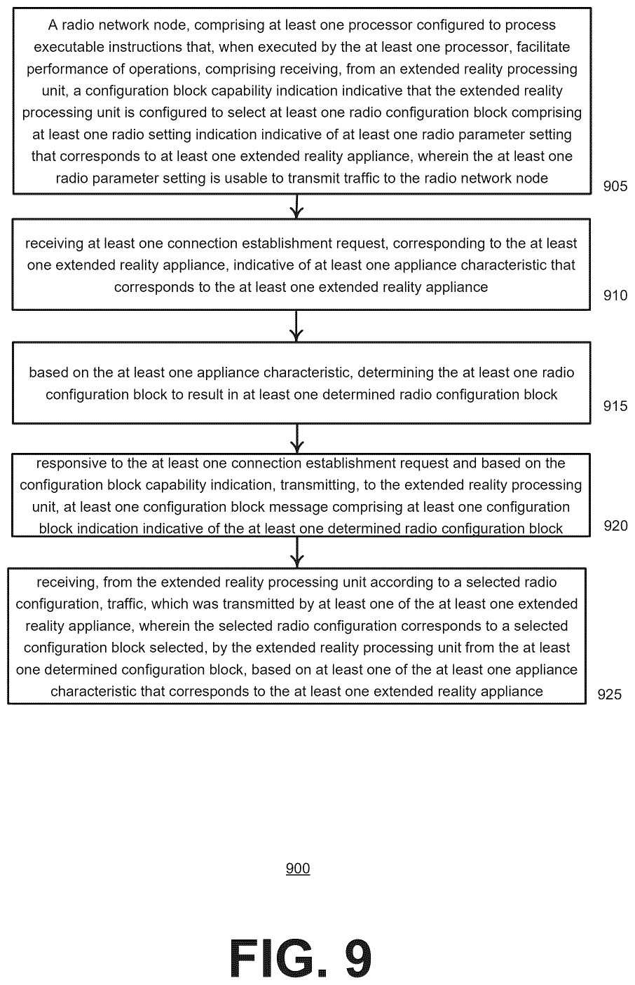

Turning now to FIG. 9, the figure illustrates a radio network node, comprising at block 905 at least one processor configured to process executable instructions that, when executed by the at least one processor, facilitate performance of operations, comprising receiving, from an extended reality processing unit, a configuration block capability indication indicative that the extended reality processing unit is configured to select at least one radio configuration block comprising at least one radio setting indication indicative of at least one radio parameter setting that corresponds to at least one extended reality appliance, wherein the at least one radio parameter setting is usable to transmit traffic to the radio network node; at block 910 receiving at least one connection establishment request, corresponding to the at least one extended reality appliance, indicative of at least one appliance characteristic that corresponds to the at least one extended reality appliance; at block 915, based on the at least one appliance characteristic, determining the at least one radio configuration block to result in at least one determined radio configuration block; at block 920, responsive to the at least one connection establishment request and based on the configuration block capability indication, transmitting, to the extended reality processing unit, at least one configuration block message comprising at least one configuration block indication indicative of the at least one determined radio configuration block; and at block 925 receiving, from the extended reality processing unit according to a selected radio configuration, traffic, which was transmitted by at least one of the at least one extended reality appliance, wherein the selected radio configuration corresponds to a selected configuration block selected, by the extended reality processing unit from the at least one determined configuration block, based on at least one of the at least one appliance characteristic that corresponds to the at least one extended reality appliance.

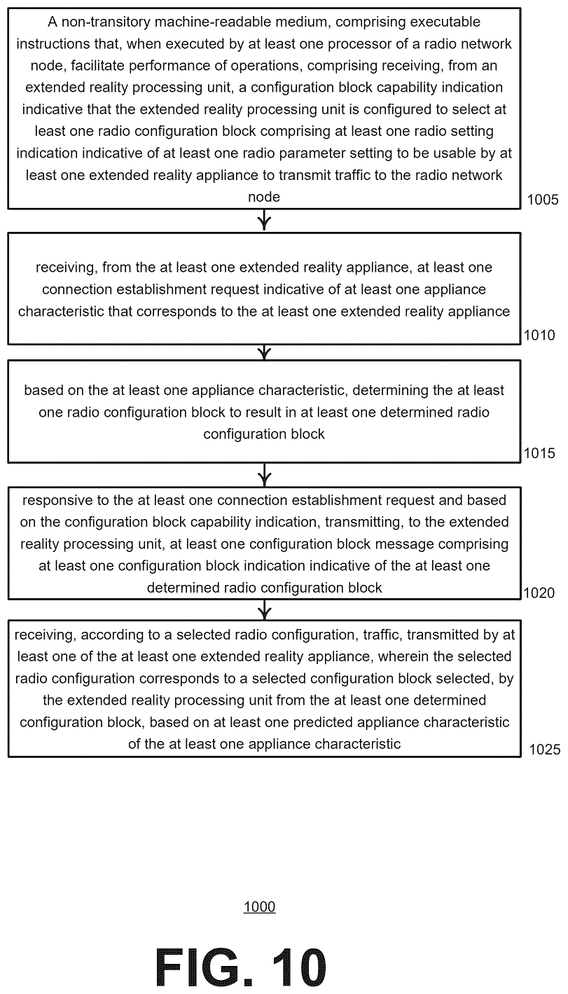

Turning now to FIG. 10, the figure illustrates a non-transitory machine-readable medium 1000 comprising at block 1005 executable instructions that, when executed by at least one processor of a radio network node, facilitate performance of operations, comprising, receiving, from an extended reality processing unit, a configuration block capability indication indicative that the extended reality processing unit is configured to select at least one radio configuration block comprising at least one radio setting indication indicative of at least one radio parameter setting to be usable by at least one extended reality appliance to transmit traffic to the radio network node; a block 1010 receiving, from the at least one extended reality appliance, at least one connection establishment request indicative of at least one appliance characteristic that corresponds to the at least one extended reality appliance; at block 1015 based on the at least one appliance characteristic, determining the at least one radio configuration block to result in at least one determined radio configuration block; at block 1020 responsive to the at least one connection establishment request and based on the configuration block capability indication, transmitting, to the extended reality processing unit, at least one configuration block message comprising at least one configuration block indication indicative of the at least one determined radio configuration block; and at block 1025 receiving, according to a selected radio configuration, traffic, transmitted by at least one of the at least one extended reality appliance, wherein the selected radio configuration corresponds to a selected configuration block selected, by the extended reality processing unit from the at least one determined configuration block, based on at least one predicted appliance characteristic of the at least one appliance characteristic.

In order to provide additional context for various embodiments described herein, FIG. 11 and the following discussion are intended to provide a brief, general description of a suitable computing environment 1100 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per sc.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors and may include a cache memory. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

Computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid-state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can comprise a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Turning now to FIG. 12, the figure illustrates a block diagram of an example UE 1260. UE 1260 may comprise a smart phone, a wireless tablet, a laptop computer with wireless capability, a wearable device, a machine device that may facilitate vehicle telematics, and the like. UE 1260 comprises a first processor 1230, a second processor 1232, and a shared memory 1234. UE 1260 includes radio front end circuitry 1262, which may be referred to herein as a transceiver, but is understood to typically include transceiver circuitry, separate filters, and separate antennas for facilitating transmission and receiving of signals over a wireless link, such as one or more wireless links 125, 135, or 137 shown in FIG. 1. Furthermore, transceiver 1262 may comprise multiple sets of circuitry or may be tunable to accommodate different frequency ranges, different modulations schemes, or different communication protocols, to facilitate long-range wireless links such as links, device-to-device links, such as links 135, and short-range wireless links, such as links 137.

Continuing with description of FIG. 12, UE 1260 may also include a SIM 1264, or a SIM profile, which may comprise information stored in a memory (memory 1234 or a separate memory portion), for facilitating wireless communication with RAN 105 or core network 130 shown in FIG. 1. FIG. 12 shows SIM 1264 as a single component in the shape of a conventional SIM card, but it will be appreciated that SIM 1264 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 1264 and another device, which may be a component of RAN 105 or core network 130 shown in FIG. 1). A SIM profile 1264 may also comprise identifying information that is unique to the SIM, or SIM profile, such as, for example, an International Mobile Subscriber Identity (“IMSI”) or information that may make up an IMSI.

SIM 1264 is shown coupled to both the first processor portion 1230 and the second processor portion 1232. Such an implementation may provide an advantage that first processor portion 1230 may not need to request or receive information or data from SIM 1264 that second processor 1232 may request, thus eliminating the use of the first processor acting as a ‘go-between’ when the second processor uses information from the SIM in performing its functions and in executing applications. First processor 1230, which may be a modem processor or baseband processor, is shown smaller than processor 1232, which may be a more sophisticated application processor, to visually indicate the relative levels of sophistication (i.e., processing capability and performance) and corresponding relative levels of operating power consumption levels between the two processor portions. Keeping the second processor portion 1232 asleep/inactive/in a low power state when UE 1260 does not need it for executing applications and processing data related to an application provides an advantage of reducing power consumption when the UE only needs to use the first processor portion 1230 while in listening mode for monitoring routine configured bearer management and mobility management/maintenance procedures, or for monitoring search spaces that the UE has been configured to monitor while the second processor portion remains inactive/asleep.

UE 1260 may also include sensors 1266, such as, for example, temperature sensors, accelerometers, gyroscopes, barometers, moisture sensors, and the like that may provide signals to the first processor 1230 or second processor 1232. Output devices 1268 may comprise, for example, one or more visual displays (e.g., computer monitors, VR appliances, and the like), acoustic transducers, such as speakers or microphones, vibration components, and the like. Output devices 1268 may comprise software that interfaces with output devices, for example, visual displays, speakers, microphones, touch sensation devices, smell or taste devices, and the like, that are external to UE 1260.

The following glossary of terms given in Table 1 may apply to one or more descriptions of embodiments disclosed herein.

TABLE 1

| Term | Definition |
|---|---|
| UE | User equipment |
| WTRU | Wireless transmit receive unit |
| RAN | Radio access network |
| QoS | Quality of service |
| DRX | Discontinuous reception |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| UE | User equipment |
| CBR | Channel busy ratio |
| SCI | Sidelink control information |
| SBFD | Sub-band full duplex |
| CLI | Cross link interference |
| TDD | Time division duplexing |
| FDD | Frequency division duplexing |
| BS | Base-station |
| RS | Reference signal |
| CSI-RS | Channel state information reference signal |
| PTRS | Phase tracking reference signal |
| DMRS | Demodulation reference signal |
| gNB | General NodeB |
| PUCCH | Physical uplink control channel |
| PUSCH | Physical uplink shared channel |
| SRS | Sounding reference signal |
| NES | Network energy saving |
| QCI | Quality class indication |
| RSRP | Reference signal received power |
| PCI | Primary cell ID |
| BWP | Bandwidth Part |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
facilitating, by a radio network node comprising at least one processor, receiving, from at least one first user equipment, a configuration block capability indication indicative that the at least one first user equipment is configured to facilitate operation of at least one second user equipment according to at least one radio configuration to be selectable by the at least one first user equipment with respect to at least one user equipment characteristic that corresponds to the at least one second user equipment;
facilitating, by the radio network node, receiving at least one connection establishment request corresponding to the at least one second user equipment;
based on at least one radio characteristic that corresponds to the at least one second user equipment, determining, by the radio network node, the at least one radio configuration associated with the at least one radio characteristic;
responsive to the at least one connection establishment request and based on the configuration block capability indication, facilitating, by the radio network node, transmitting, to the at least one first user equipment, at least one configuration block message comprising at least one configuration block indicative of the at least one radio configuration; and
facilitating, by the radio network node, receiving traffic that was transmitted, by at least one of the at least one second user equipment, according to at least one of the at least one radio configuration.

2. The method of claim 1, wherein the at least one radio characteristic comprises at least one application type associated with at least one application to be executed by the at least one second user equipment.

3. The method of claim 1, wherein the at least one radio characteristic comprises at least one quality of service that corresponds to at least one communication session to be conducted between one or more of the at least one second user equipment and the radio network node.

4. The method of claim 1, wherein the at least one configuration block message comprises an adaptation mode indication indicative of a transparent configuration block adaptation mode, and wherein the receiving of the traffic according to the at least one of the at least one radio configuration comprises blind decoding, by the radio network node, of the traffic.

5. The method of claim 1, wherein the at least one configuration block message comprises an adaptation mode indication indicative of a nontransparent configuration block adaptation mode, and wherein the method further comprises:
facilitating, by the radio network node, receiving, from the at least one first user equipment, at least one radio configuration adaptation report indicative of at least one determined radio configuration of the at least one radio configuration;
wherein the receiving of the traffic according to the at least one of the at least one radio configuration comprises:
avoiding blind decoding of the traffic; and
receiving the traffic according to at least one radio configuration setting that corresponds to the at least one determined radio configuration indicated by the at least one radio configuration adaptation report.

6. The method of claim 5, wherein the at least one determined radio configuration is determined by the at least one first user equipment.

7. The method of claim 6, wherein determination of the at least one determined radio configuration by the at least one first user equipment comprises determination of an adapted configuration block of the at least one configuration block associated with the at least one determined radio configuration based on the at least one user equipment characteristic.

8. The method of claim 1, wherein the at least one user equipment characteristic comprises at least one haptic characteristic that corresponds to use, associated with a user action, of the at least one of the at least one second user equipment.

9. The method of claim 8, wherein the at least one haptic characteristic comprises at least one of: at least one eye movement, at least one movement of the at least one second user equipment, at least one pulse rate, at least one blood pressure value, at least one voice intonation, at least one skin moisture value, or at least one grip pressure value.

10. The method of claim 1, wherein the at least one user equipment characteristic is predicted by the at least one first user equipment, according to at least one learning model, to result in at least one predicted user equipment characteristic, and wherein the adapted configuration block is determined based on the at least one predicted user equipment characteristic.

11. The method of claim 10, wherein at least one input to the at least one learning model comprises at least one of: at least one network parameter metric representative of at least one first metric representative of at least one network parameter, at least one network traffic parameter metric representative of at least one second metric representative of at least one network traffic parameter, at least one user equipment behavior parameter metric representative of at least one third metric representative of at least one user equipment behavior parameter, or at least one user behavior parameter metric representative of at least one fourth metric representative of at least one user behavior parameter.

12. The method of claim 1, wherein the at least one user equipment characteristic comprises at least one of: at least one application characteristic associated with at least one application being executed by the at least one of the at least one second user equipment, at least one radio capability, at least one radio channel condition, or at least one quality of service associated with the at least one application.

13. The method of claim 1, wherein the at least one second user equipment is an extended reality appliance.

14. The method of claim 1, wherein the at least one first user equipment is an extended reality intermediate processing unit.

15. A radio network node, comprising at least one processor configured to process executable instructions that, when executed by the at least one processor, facilitate performance of operations, comprising:
receiving, from an extended reality processing unit, a configuration block capability indication indicative that the extended reality processing unit is configured to select at least one radio configuration block comprising at least one radio setting indication indicative of at least one radio parameter setting that corresponds to at least one extended reality appliance, wherein the at least one radio parameter setting is usable to transmit traffic to the radio network node;
receiving at least one connection establishment request, corresponding to the at least one extended reality appliance, indicative of at least one appliance characteristic that corresponds to the at least one extended reality appliance;
based on the at least one appliance characteristic, determining the at least one radio configuration block to result in at least one determined radio configuration block;
responsive to the at least one connection establishment request and based on the configuration block capability indication, transmitting, to the extended reality processing unit, at least one configuration block message comprising at least one configuration block indication indicative of the at least one determined radio configuration block; and
receiving, from the extended reality processing unit according to a selected radio configuration, traffic, which was transmitted by at least one of the at least one extended reality appliance, wherein the selected radio configuration corresponds to a selected configuration block selected, by the extended reality processing unit from the at least one determined configuration block, based on at least one of the at least one appliance characteristic that corresponds to the at least one extended reality appliance.

16. The radio network node of claim 15, wherein the operations further comprise:
receiving, from the extended reality processing unit, at least one radio configuration adaptation report indicative of the selected configuration block, and
wherein the receiving of the traffic comprises:
avoiding blind decoding of the traffic; and
receiving the traffic according to at least one radio configuration setting that corresponds to the selected radio configuration indicated by the at least one radio configuration adaptation report.

17. The radio network node of claim 16, wherein the configuration block capability indication is indicative that the extended reality processing unit is capable of using a trained machine learning model to predict the at least one of the at least one appliance characteristic to determine the selected configuration block indicated by the at least one radio configuration adaptation report.

18. A non-transitory machine-readable medium, comprising executable instructions that, when executed by at least one processor of a radio network node, facilitate performance of operations, comprising:
receiving, from an extended reality processing unit, a configuration block capability indication indicative that the extended reality processing unit is configured to select at least one radio configuration block comprising at least one radio setting indication indicative of at least one radio parameter setting to be usable by at least one extended reality appliance to transmit traffic to the radio network node;
receiving, from the at least one extended reality appliance, at least one connection establishment request indicative of at least one appliance characteristic that corresponds to the at least one extended reality appliance;
based on the at least one appliance characteristic, determining the at least one radio configuration block to result in at least one determined radio configuration block;
responsive to the at least one connection establishment request and based on the configuration block capability indication, transmitting, to the extended reality processing unit, at least one configuration block message comprising at least one configuration block indication indicative of the at least one determined radio configuration block; and
receiving, according to a selected radio configuration, traffic, transmitted by at least one of the at least one extended reality appliance, wherein the selected radio configuration corresponds to a selected configuration block selected, by the extended reality processing unit from the at least one determined configuration block, based on at least one predicted appliance characteristic of the at least one appliance characteristic.

19. The non-transitory machine-readable medium of claim 18, wherein the extended reality processing unit uses at least one trained learning model to predict the at least one predicted appliance characteristic.

20. The non-transitory machine-readable medium of claim 18, wherein the operations further comprise:
receiving, from the extended reality processing unit, at least one radio configuration adaptation report indicative of the selected configuration block;
wherein the receiving of the traffic comprises:
without performing any blind decoding of the traffic, receiving the traffic according to at least one radio configuration setting that corresponds to the selected radio configuration indicated by the at least one radio configuration adaptation report.
